(19) United States
(12) Patent Application Publication
(10) Pub. No.: US 2006/0247352 A1
(43) Pub. Date: Nov. 2, 2006

(54) EMI shielding material

(75) Inventors: Edward Bormashenko, Ariel (IL); Semyon Sutovski, Kfar-Saba (IL); Roman Pogreb, Ariel (IL); Valery Grinshpun, Haifa (IL); Alexander Zinigrad, Ariel (IL); Yelena Bormashenko, Ariel (IL)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Ariel - University Research and Development Ltd., Ariel (IL)

(21) Appl. No.: 11/118,578

(22) Filed: Apr. 29, 2005

(51) Int. Cl. C04B 26/12

(52) U.S. Cl. 524/408; 524/495

(57) ABSTRACT

The invention provides a broadband EMI shielding material and a process for making it. The material is a nonconductive nanocomposite comprising a low-melting metal alloy dispersed in a thermoplastic polymer, and the process for its preparation comprises high-shear homogenization at a temperature higher than the melting points of both the alloy and the polymer. Thermoformable articles, suitable for EMI shielding in the range of 5-100 MGz, may be made from the nanocomposite of the invention.

### FIELD OF THE INVENTION

The present invention relates to a nonconductive, metal-polymer, nanocomposite material for broadband EMI shielding, and to a process for producing it.

### BACKGROUND OF THE INVENTION

The interference caused by electromagnetic waves, abbreviated as EMI, may be filtered off by shielding layers of various materials containing metals. Most applications require that the shielding material be light and easily thermoformable. U.S. Pat. No. 4,533,685 describes electrically conducting blends of metals and organic polymers obtained by a process of simultaneous melting said metal and said polymer, which process comprises mixing a molten metal with a polymer until the blend is conducting. U.S. Pat. No. 4,882,227 demonstrates the EMI shielding properties of a conductive composition comprising a low-melting metal and a thermoplastic resin. U.S. Pat. No. 5,124,198 describes a thermoformable metal-polymer composite with a conductive surface, having EMI shielding properties, comprising a low-melting metal in the form of fibers having a diameter of about 10-200 μm. U.S. Pat. No. 5,226,210 describes a method for producing a metal-polymer composite with EMI shielding properties, comprising embedding a metal mat into a polymeric substrate at a temperature less than the melting point of said metal, wherein said fibers have a diameter of about 25-100 μm. US 2004/0239578 describes an electromagnetic absorbing device comprising a resin-based material containing conductive particles of a dimension from micrometers to millimeters.

In view of the exponentially increasing number of both sources and receivers of the radiation in the environment, belonging for example to numerous cellular phone systems, an urgent need is felt for new EMI shielding materials. New requirements are raised for the properties of the shielding materials. For example, the homogeneity of the components in composite materials is beneficial in numerous applications, and the dispersion of the components from microdimensions down to nanodimensions is desired. Various applications would also benefit from nonconductive shielding materials. Further, broadband EMI shielding comprising shorter wavelengths is required. It is therefore an object of this invention to provide a novel, light and thermoformable, EMI shielding material, which comprises metal-polymer composites.

It is a further object of the invention to provide an EMI shielding material, which comprises a nonconductive metal-polymer composite.

It is a still further object of the invention to provide an EMI shielding material, which comprises a metal-polymer nanocomposite.

It is also an object of the invention to provide a broadband EMI shielding material, covering frequencies 10-100 GHz, for producing thermoformable articles.

Other objects and advantages of present invention will appear as description proceeds.

### SUMMARY OF THE INVENTION

The present invention provides a nonconductive, composite material comprising from 5 to 40 wt % low-melting metal alloy, from 60 to 95 wt % thermoplastic polymer, and optionally up to 3 wt % of a solid filler. Said filler is selected from carbon powders, carbon fibers, metal powders, metal fibers, and their mixtures. The material of the invention has a specific resistivity of at least 10⁸ Ωcm. Said low melting alloy has a melting point lower than 250° C., and comprises metals selected from the group consisting of Sn, Bi, Pb, Zn, Sb, Cd, Na, and In. Said polymer is preferably selected from polyethylene, polypropylene, polystyrene, copolymers of polystyrene, polycarbonate, polyethylene terephthalate, polymethylmeth-acrylate, and polysulfone. The nonconductive composite material of the invention is preferably a nanocomposite material, comprising metal particles dispersed in a polymeric matrix, wherein said particles have average dimensions lower than 800 nm. In a preferred embodiment of the invention, said metal particles dispersed in said matrix have mostly dimensions lower than 80 nm. The material of the invention preferably comprises from 15 to 25 wt % low melting alloy and 75 to 85 wt % thermoplastic polymer. Said filler is preferably selected from carbon powder and carbon fibers. In a preferred embodiment of the composite of the invention, the melting point of said alloy is up to 160° C. Said resistivity of the composite material is preferably at least 10¹⁰ Ωcm. The nonconductive composite material of the invention may be used for shielding frequencies from 0.1 to 100 GHz. The material effectively shields electromagnetic interference for frequencies higher than 5 GHz, and is preferably used in the range of from 10 to 100 GHz. The electromagnetic waves are attenuated with effectiveness higher than 30 dB/cm (calculated for thickness of 1 cm).

The invention relates to a process of preparing nonconductive composite material, comprising i) providing a low melting alloy having a melting point lower than 250° C.; ii) providing a thermoplastic polymer; iii) mixing said alloy from step i) in an amount of from 5 to 40 wt % with said polymer from step ii) in an amount of from 60 to 95 wt %, optionally with a solid filler in an amount of up to 3 wt %, at a temperature (first processing temperature) higher than said melting point of the alloy and also higher than melting/softening point of said polymer, under high shear stress, thereby obtaining a molten homogeneous mixture of nonconductive nanocomposite, which mixture may be cooled and palletized and used later in the further steps, or without cooling used in further steps immediately; iv) mixing said mixture from step iii) under lower shear stress than applied in step iii), and at a temperature which is near to the melting point of said plastic or said alloy—whichever is higher (second processing temperature), thereby obtaining molten nonconductive nanocomposite; and optionally v) mixing said molten nanocomposite with a filler selected from carbon powders, carbon fibers, metal powders, metal fibers, and their mixtures in an amount of up to 3 wt %. A skilled person understands that polymers may first soften and pass through various stages of fluidity before attaining a substantial viscosity decrease; therefore, the term melting temperature in respect to polymers is used in this specification to denote a minimal temperature at which the material may be reasonably mixed with molten low-melting metal. The process of the invention preferably further comprises cooling and peletizing, thereby obtaining solid nonconductive nanocomposite. In a preferred process, said alloy is in an amount of from 15 to 25 wt %, said polymer in an amount of from 75 to 85 wt %, and said filler is selected from carbon powder and carbon fibers. The melting point of said low melting alloy is preferably up to 160° C., said alloy comprising a metal selected from Sn, Bi, Pb, Zn, Sb, Cd, Na, and In, and a polymer selected from polyethylene, polypropylene, polystyrene, copolymers of polystyrene, polycarbonate, polyethylene terephthalate, polymethylmethacrylate, and polysulfone. The process preferably provides a solid nanocomposite that has a resistivity of at least 10¹⁰ Ωcm, and comprises metal particles having an average diameter of less than 800 nm. In one embodiment, said polymer in the process of the invention has a viscosity lower than said alloy at said first processing temperature, thereby achieving anisotropic dielectric constant of the resulting composite. In another embodiment said polymer in the process of the invention has a viscosity higher than said alloy at said first processing temperature, thereby achieving isotropic dielectric constant of the resulting composite.

The invention further provides a thermoformable article, comprising a nonconductive composite material comprising from 5 to 40 wt % low-melting metal alloy, from 60 to 95 wt % thermoplastic polymer, and optionally up to 3 wt % of a solid filler selected from carbon powders, carbon fibers, metal powders, metal fibers, and their mixtures, wherein the composite has a specific resistivity of at least 10⁸ Ωcm. Said article is preferably prepared by molding said composite material at a temperature higher than the melting temperatures of both said alloy and said polymer.

### BRIEF DESCRIPTION OF THE DRAWINGS

The above and other characteristics and advantages of the invention will be more readily apparent through the following examples, and with reference to the appended drawings, wherein:

FIG. 1. is scheme of a process for preparing a composite material of the invention; and

FIG. 2. is a graph showing the frequency dependence of the attenuation effectiveness for a nanocomposite according to the invention (described in Example 6).

### DETAILED DESCRIPTION OF THE INVENTION

It has now been found that a superb EMI shielding material may be produced on a basis of polymer matrix, low-melting metallic alloy, and optionally a filler in a two stage process, wherein said polymer and said alloy are heated to a temperature higher than their melting temperatures comprising a high shear stress in the first stage, thereby obtaining a homogeneous nano-mixture which may be cooled and palletized for later use in the second stage, or it may be used immediately in said second stage. Said nano-mixture is then homogenized at a lower temperature and at a lower shear stress in the second stage, wherein the temperature in said second stage is nearer to the melting points of the alloy and polymer, while keeping the mixture fluid.

The material of the invention is a nonconductive composite, broadband EMI shielding material usable also for high frequencies (0.1-100 GHz). The material is produced by a two stage mixing process. The first stage comprises high velocities of impeller (up to 5000 rpm) and high shear stresses, as high as 10⁷ Pa. In the first stage, the processing temperature is higher than melting/softening points of the thermoplastic matrix and the low-melting alloy, and additives (such as Bi or small quantities of Cu) may be added to decrease the surface tension, of the alloy under the temperature of processing, for example. At this stage low melting alloy is dispersed in polymer matrix at a nanoscale level. After the first stage, the molten mixtures either continues to be processed in the second stage, or the molten mixture is cooled and palletized to provide pellets of bi-component composite. In the second stage further components, such as fillers, may be introduced and mixed under low velocities of impeller (screw) (up to 300 rpm) and low shear stresses. An EMI shielding nonconductive material is obtained in said two-stage processing, with dielectric constant affected by such factors as the presence of various fillers and their spatial distribution, which material comprises thermoplastic matrix, low-melting alloy, and a third component such as carbon black or carbon or metallic fibers, wherein the processing temperature at the first stage is higher than melting/softening points of the thermoplastic matrix and the alloy. When the components are in the liquid phase, additives decreasing the surface tension or otherwise adjusting the properties of the molten mixture may be used. In the second stage infusible components are introduced under extrusion processing. Changes in the extrusion parameters, such as temperature regimen and screw velocity, allow the formation of both isotropic and anisotropic spatial distribution of dielectric constant. Two liquid phases mixing according to the above process allows the complete separation of the metal particles, providing metal alloy nanoparticles surrounded by nonconductive polymer shell, avoiding the percolation type conductivity. The nonconductive material prevents undesired phenomena associated with the streams induced by external electromagnetic fields, or with the reflections of electromagnetic fields by the EMI shielding material.

The invention thus relates to a process of preparing nonconductive composite material preferably comprising i) providing a low melting alloy having a melting point (Talloy) lower than 250° C.; ii) providing a thermoplastic polymer having melting/softening point Tₚₒₗ; iii) mixing said alloy in an amount of from 5 to 40 wt % with said polymer in an amount of from 60 to 95 wt %, optionally with a solid filler in an amount of up to 3 wt %, at a first processing temperature that is higher than Talioy and also higher than Tₚₒₗ, under high shear stress, thereby obtaining a homogeneous mixture; iv) mixing said mixture under a shear stress lower than applied before, and lowering the temperature to a value near to the higher of values Talloy and Tₚₒₗ, (second processing temperature), thereby obtaining molten nonconductive nanocomposite; and finally optionally v) mixing said molten nanocomposite with a filler selected from carbon powders, carbon fibers, metal powders, metal fibers, and their mixtures in an amount of up to 3 wt %.

In one aspect, the invention relates to a composite EMI shielding material based on a thermoplastic polymer, and a low melting alloy dispersed in the polymer matrix, and solid filler such as carbon black or carbon or metal fibers, which material contains nanosized metallic particles formed under the conditions of mixing the components under the temperature which is higher than both melting/softening points of thermoplastic matrix and low melting point alloy. In an important embodiment, additives are used in the molten mixture during the production of the composite, which decrease the surface tension under the conditions of liquid/liquid phase mixing of the components. Introducing a solid filler may enhance EMI shielding properties of the composite. Solid fillers are introduced when both polymer matrix and low melting alloy are in the liquid state.

In another aspect of the invention, the dielectric constant of the composite is controlled due to controlled size distribution of the alloy particles, as well as due to controlled spatial distribution of the alloy particles. The process of absorption of electromagnetic radiation in the composite is determined by multiple reflections of electromagnetic waves caused by metal alloy particles. Thus controlled spatial distribution of the alloy particles, as well as controlled size distribution thereof, enable required changes in the dielectric constant.

The component forming the nanocomposite material of the invention may be extruded and mixed under the temperature, which is higher than the melting point of the alloy or than the melting point of the thermoplast or than both.

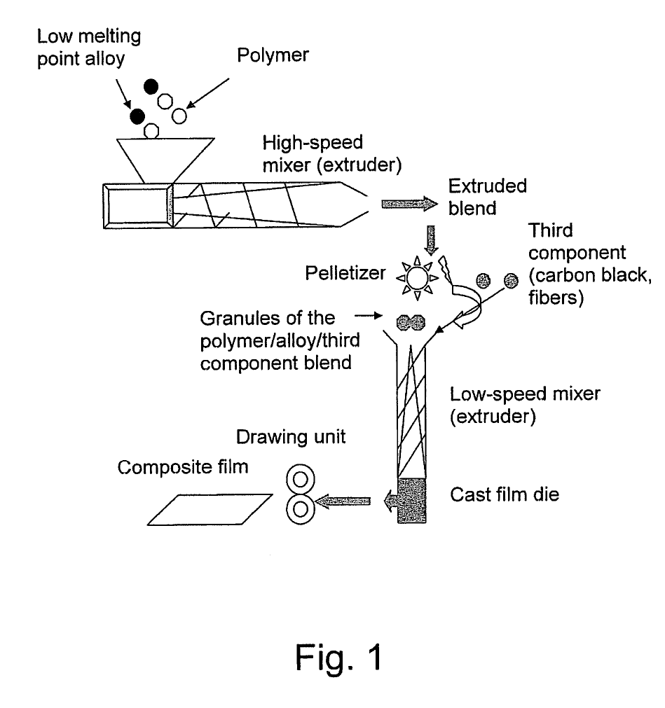

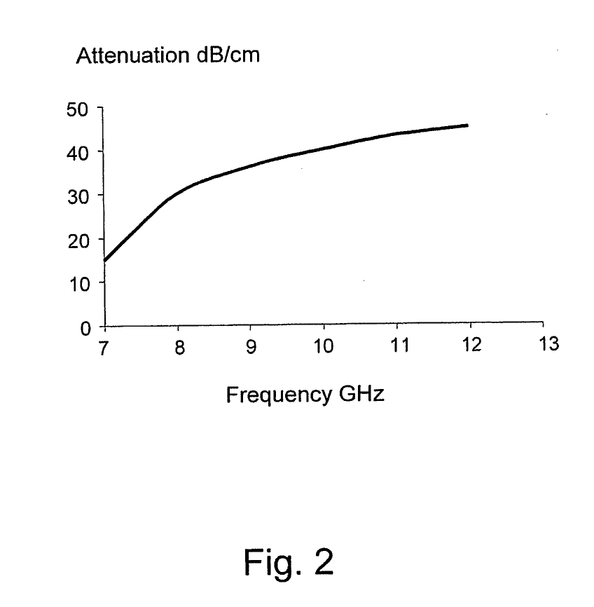

Two-stage mixing of the components, in the process of the invention, affects the dispersal of the materials, so that the required features are attained. FIG. 1 shows schematically an embodiment of the process for producing an EMI shield. In the first stage, the first processing temperature is substantially higher than melting points of the alloy and the polymer. Said first processing temperature, for example, may be by 50° C. higher than the higher of values T_{alloy} and Tₚₒₗ. In the second stage, the temperature is lowered to the vicinity of values T_{alloy} and Tₚₒₗ. The second processing temperature, for example, may be by 10° C. higher than the higher of values T_{alloy} and Tₚₒₗ, Mixing components at two stages differing by the temperatures, and shear stresses and velocities of the impeller, results in the desired dispersion. Other important parameters of the process, affecting the properties of the nanocomposite, include the surface tension and viscosity of the molten mixture, which may be influenced by additives. For example, a polymer viscosity higher than alloy viscosity, under the processing temperature, results in an isotropic distribution of the alloy leading to the isotropic dielectric constant of the composite, whereas using a polymer with a viscosity lower than that of the alloy, under processing temperature, results in an anisotropic distribution of the alloy, leading to the anisotropic dielectric constant of the resulting composite. In a preferred embodiment, an EMI shield is obtained that is effective for frequencies higher than 5 GHz. For example, a nanocomposite comprising 15 wt % alloy and 85 wt % LDPE Ipethene 4203 yielded an attenuation effectiveness of more than 30 dB for frequencies higher than 9 GHz, for a thickness of about 1 cm (FIG. 2).

The formation of nanosized low-melting alloy particles, dispersed in the polymer matrix under conditions of extrusion mixing, when both thermoplastic polymer and low melting alloy are in the liquid state, favors a dramatic enhancement of the imaginary part of the dielectric constant, thus enhancing EMI shielding properties of the composite.

The invention will be further described and illustrated in the following examples.

### EXAMPLES

### Example 1

EMI shielding composite comprising 20% weight percents of low melting alloy and 80% weight percents of low density polyethylene was manufactured. Low melting alloy comprised Sn 42% and Bi 58%. Melting point of the alloy was 139° C., density was 8.75 g/cm³. Low density polyethylene (LDPE) Ipethene 320 was used, produced by Carmel Olefinim Ltd (Israel), having melt flow index of 2.0 g/10 min (ISO 1183, t=190° C.), density 0.92 g/cm3. The first stage of the mixing was performed in the disperser Turbomix, under the temperature of 250° C., during 10 min, velocity of the impeller was 5000 rpm. Afterwards the composite was cooled and pelletized. The second stage of the mixing was performed in the single-screw extruder, equipped with a cast film die, under the temperature of 200° C., velocity of the screw was 60 rpm. The film with a thickness of 100 μm was manufactured. Uniform distribution of components in the film was achieved. Average diameter of the low melting alloy particles was determined with SEM microscopy as 250 nm. DC specific resistivity of the film was determined as 2×10¹⁰ Ωcm (determined according “four points method”). Dielectric constant of the composite was determined as ε′=2.4, ε″=0.4, at 1 GHz frequency, ε′=24, ε″=18 at 10 GHz.

### Example 2

EMI shielding composite was manufactured as in Example 1. At the second stage of the mixing process, 2% of the carbon fibers were added. Average diameter of the low melting alloy particles was determined with SEM microscopy to be 200 nm. DC specific resistivity was determined as 7×10⁸ Ωcm (determined according “four points method”). Dielectric constant of the composite was determined as ε′=11.2, ε″=0.5, at 1 GHz frequency, ε″=25, ε″=24 at 10 GHz.

### Example 3

EMI shielding composite was manufactured as described in Example 1. At the second stage of the mixing process, 2% of carbon black is added. Average diameter of the low melting alloy particles was determined with SEM microscopy as being 200 nm. Specific resistivity (DC) was determined as 3×10¹⁰ Ωcm. Dielectric constant of the composite was determined as ε″=2.4, ε″=0.3, at 1 GHz frequency, ε′=11, ε″=2.5 at 10 GHz.

### Example 4

EMI shielding composite comprising 15% weight percents of low melting alloy and 85% weight percents of low density, low-viscosity, polyethylene was manufactured. Low melting alloy comprises Sn 45%, Zn 20%, and Cd 35%. Melting point of the alloy is 160° C. Low density, low-viscosity polyethylene is Ipethene 320, produced by Carmel Olefinim Ltd, melt flow index of LDPE was 2.0 g/10 min (ISO 1183, t=190° C.), density was 0.92 g/cm3. At the first stage pellets of the composite were obtained with twin-screw extruder: temperature was 250° C., velocity of the screw was 330 rpm. Obtained composite was cooled and pelletized. The second stage of processing was performed in the single-screw-extruder Randcastle, equipped with cast film die, under a temperature of 190° C., and screw velocity of 120 rpm. Melted composite was processed in the film with thickness 100 μm. Average diameter of the low melting alloy particles was determined with SEM microscopy as 600 nm. Uniform distribution of dielectric constant was revealed. Specific resistivity (DC) was determined as 5×10¹⁰ Ωcm. Dielectric constant of the composite, measured at a frequency of 10 GHz, equaled ε″=10.2, ε″=14.0. The dielectric constant of the composite as measured at the frequency 0.6 GHz equaled: ε′=2.1, ε″=0.3.

### Example 5

EMI shielding composite was manufactured as described in Example 4. Low melting alloy comprised Sn 22%, Pb 22%, and Bi 56%. Melting point of the alloy was 110° C. Average diameter of the low melting alloy particles was determined with SEM microscopy as 150 nm. Uniform distribution of dielectric constant was revealed. Specific resistivity (DC) was determined as 5×10¹⁰ Ωcm. Dielectric constant of the composite as measured at a frequency of 10 GHz equaled: ε′=18.2, ε″=24.0. Dielectric constant of the composite as measured at a frequency of 0.6 GHz equaled: ε′=2.5, ε″=0.4.

### Example 6

EMI shielding composite was manufactured as described in Example 4. Low density, high-viscosity polyethylene Ipethene 4203, produced by Carmel Olefinim Ltd. was used as matrix instead of low density, low-viscosity polyethylene. Melt flow index of LDPE Ipethene 4203 was 0.2 g/10 min (ISO 1183, t=190° C.). The attenuation effectiveness of the shielding material is shown in FIG. 2. Non-uniform, strictly oriented distribution of the alloy particles was revealed, comprising aligning elongated particles in the direction of pulling forces arising during the extrusion process, which favors the formation of non-uniform dielectric constant. Dielectric constant of the composite as measured in the drawing direction at a frequency of 10 GHz equaled: ε′=17.2, ε″=21.0; at a frequency of 0.6 GHz it equaled: ε′=2.4, ε″=0.3.

### Example 7

EMI shielding composite comprising 30% weight percents of low melting alloy (described in Example 5: Sn 22%, Pb 22%, Bi 56%), 69% weight percents of low density polyethylene Ipethene 320, and 1% of carbon fibers were processed under conditions described in Example 4. Average diameter of the low melting alloy particles was determined with SEM microscopy as 200 nm. Uniform distribution of dielectric constant was revealed. Dielectric constant of the composite as measured at frequency 0.6 GHz equaled: ε′=10.6, ε″=21.0.

### Example 8

EMI shielding composite comprising 30% weight percents of low melting alloy as described in Example 5, 69% weight percents of low density polyethylene Ipethene 320, and 1% of carbon black were processed under conditions described in Example 4. Average diameter of the low melting alloy particles was determined with SEM microscopy as 200 nm. DC specific resistivity was determined as 10⁸ Ωcm (determined according to “four points method”). Uniform distribution of dielectric constant was revealed. Dielectric constant was determined as isotropic. Dielectric constant of the composite as measured at frequency 0.6 GHz equaled: ε′=10.6, ε″=21.0. Dielectric constant of the composite as measured at frequency 10 GHz equaled: ε′=20.2, ε″=24.0

While this invention has been described in terms of some specific examples, many modifications and variations are possible. It is therefore understood that within the scope of the appended claims, the invention may be realized otherwise than as specifically described.

1. A nonconductive composite material comprising from 5 to 40 wt % low-melting metal alloy, from 60 to 95 wt % thermoplastic polymer, and up to 3 wt % of a solid filler.

2. A nonconductive composite material according to claim 1, wherein said filler is selected from carbon powders, carbon fibers, metal powders, metal fibers, and their mixtures.

3. A nonconductive composite material according to claim 1, having a specific resistivity of at least 10⁸ Ωcm.

4. A nonconductive composite material according to claim 1, wherein said low melting alloy has a melting point lower than 250° C.

5. A nonconductive composite material according to claim 1, wherein said alloy comprises a metal selected from the group consisting of Sn, Bi, Pb, Zn, Sb, Cd, Na, and In.

6. A nonconductive composite material according to claim 1, wherein said polymer is selected from the group consisting of polyethylene, polypropylene, polystyrene, copolymers of polystyrene, polycarbonate, polyethylene terephthalate, polymethylmethacrylate, and polysulfone.

7. A nonconductive composite material according to claim 1, wherein said composite material is a nanocomposite.

8. A nonconductive composite material according to claim 1, comprising from 15 to 25 wt % low melting alloy and 75 to 85 wt % thermoplastic polymer.

9. A nonconductive composite material according to claim 1, wherein said filler is selected from carbon powder and carbon fibers.

10. A nonconductive composite material according to claim 4, wherein said melting point is up to 160° C.

11. A nonconductive composite material according to claim 3, wherein said resistivity is at least 10¹⁰ Ωcm.

12. A nonconductive composite material according to claim 1, wherein the particles of said low-melting alloy have an average diameter of less than 800 nm.

13. A nonconductive composite material according to claim 12, wherein the particles of said low-melting alloy have an average diameter of less than 80 nm.

14. A nonconductive composite material according to claim 1, efficient in shielding electromagnetic interference (EMI) for a frequency higher than 5 GHz.

15. A nonconductive composite material according to claim 14, wherein said frequency is from 10 to 100 GHz.

16. A nonconductive composite material according to claim 15, having attenuation effectiveness higher than 30 dB/cm.

17. A process of preparing nonconductive composite material of claim 1, comprising
i) providing a low melting alloy having a melting point lower than 250° C.;
ii) providing a thermoplastic polymer;
iii) mixing said alloy from step i) in an amount of from 5 to 40 wt % with said polymer from step ii) in an amount of from 60 to 95 wt %, optionally with a solid filler in an amount of up to 3 wt %, at a temperature higher than the melting point of said alloy and also higher than melting/softening point of said polymer (first processing temperature), under high shear stress, thereby obtaining a homogeneous mixture;
iv) mixing said mixture from step iii) under lower shear stress than applied in step iii), and at a temperature which is near to the melting point of said plastic or said alloy—whichever is higher (second processing temperature), thereby obtaining molten nonconductive nanocomposite; and optionally
v) mixing said molten nanocomposite with a filler selected from carbon powders, carbon fibers, metal powders, metal fibers, and their mixtures in an amount of up to 3 wt %.

18. A process according to claim 17, further comprising cooling and peletizing, thereby obtaining a solid nonconductive nanocomposite.

19. A process according to claim 17, wherein said nanocomposite material is effective in EMI shielding.

20. A process according to claim 17, wherein said alloy is in an amount of from 15 to 25 wt % and said polymer in an amount of from 75 to 85 wt %.

21. A process according to claim 17, wherein said filler is selected from carbon powder and carbon fibers.

22. A process according to claim 17, wherein the melting point of said low melting alloy is up to 160° C.

23. A process according to claim 17, wherein said alloy comprises a metal selected from Sn, Bi, Pb, Zn, Sb, Cd, Na, and In.

24. A process according to claim 17, wherein said polymer is selected from polyethylene, polypropylene, polystyrene, copolymers of polystyrene, polycarbonate, polyethylene terephthalate, polymethylmethacrylate, and polysulfone.

25. A process according to claim 17, wherein said solid nanocomposite has a resistivity of at least 10¹⁰ Ωcm.

26. A process according to claim 17, wherein said solid nanocomposite comprises metal particles having an average diameter of less than 800 nm.

27. A process according to claim 17, wherein said polymer has a viscosity lower than said alloy at said first processing temperature, such that the resulting composite material has an anisotropic dielectric constant.

28. A process according to claim 17, wherein said polymer has a viscosity higher than said alloy at said first processing temperature, such that the resulting composite material has an isotropic dielectric constant.

29. A thermoformable article, comprising the composite material of claim 1.

30. A thermoformable article prepared by molding the composite material of claim 1 at a temperature higher than the melting temperatures of both said alloy and said polymer.

31. An EMI shielding article prepared from the composite material of claim 1.
